(19) United States
(12) Patent Application Publication
(10) Pub. No.: US 2009/0191974 A1
(43) Pub. Date: Jul. 30, 2009

(54) Flexible drive shaft

(75) Inventors: Herbert Weissenbock, Feistritz am Wechsel (AT); Christoph Kment, Vienna (AT); Jurgen Kolndorfer, Vienna (AT)

Correspondence Address: CHAPMAN AND CUTLER, 111 WEST MONROE STREET, CHICAGO, IL, 60603, US

(73) Assignee: IMA Integrated Microsystems Austria GmbH, Wiener Neustadt (AT)

(21) Appl. No.: 12/319,938

(22) Filed: Jan. 14, 2009

(30) Foreign Application Priority Data
Jan. 15, 2008 (AT) GM 26/2008

(51) Int. Cl. F16D 3/56

(52) U.S. Cl. 464/56

(57) ABSTRACT

In a flexible drive shaft, guided rotatably in a curved, preferably bendable tube (1), with an end piece (2, 3) on the driving side and on the output side, the flexible shaft is formed by a plurality of segments (4) arranged between the two end pieces (2, 3) at a distance from each other, which are connected by means of flexible connecting elements (5, 6, 7, 8) with each other and with the end pieces (2, 3) for the transmission of the rotary movement.

Priority is claimed to Austria Pat. App. Ser. No. GM 26/2008, filed Jan. 15, 2008, hereby incorporated by reference in its entirety.

The invention relates to a flexible drive shaft rotatably guided in a curved, preferably bendable tube, with an end piece on the driving side and an end piece on the output side.

Flexible or bendable drive shafts are used when the element which is to be driven is movable and the drive source can not, or is not to be moved also, or when the object which is to be moved can not be reached directly. Flexible drive shafts are used for example in hand-operated working apparatus, such as for example in surgical instruments, where a tool head is to be driven to corresponding rotation. These may be drilling- or grinding heads or suchlike here.

A range of proposals exist for power transmission in curved hollow shafts, in which these systems are usually based on a spiral spring which can rotate in an outer covering which is likewise formed from a spring structure. Through the spring structure, a generally undesired spring action is produced with rotation forces, whereby the drive shaft or the drive spring can change in its diameter, which can lead to increased friction on the wall of the outer covering. An improved embodiment of a flexible shaft for power transmission is known from U.S. Pat. No. 6,533,749, where the said disadvantage of spring action or deformation on loading is to be prevented by two flat spring structures which are joined into each other. However, the construction described therein leads to intensified problems through frictional heat through the large sliding surfaces of the flat spring structure.

In EP 986 989 A1 a further embodiment is described of a flexible drive shaft, in which meander-shaped notches alternately define teeth and indentations of wave segments, with a tooth being arranged in turn in each indentation and each tooth being arranged in an indentation. However, this system entails an extraordinary amount of friction and therefore leads to a great heat development.

The present invention aims to provide a flexible drive shaft by which great torques can be transmitted and which is also suited for high numbers of revolutions in the range of several 1000 revolutions per minute. In addition, the negative effects of spring structures and suchlike, connected with the conventional systems, are to be avoided and friction losses are to be reduced as much as possible. Furthermore, the possibility is to be provided of transporting media such as, for instance, cooling gas, flushing agent and suchlike through the flexible shaft.

To solve this problem, the drive shaft according to the invention is distinguished substantially in that the flexible shaft is formed by a plurality of segments arranged at a distance from each other between the two end pieces, which segments are connected by means of flexible connecting elements with each other and with the end pieces for the transmission of the rotary movement. Through the flexible shaft being formed by several segments arranged at a distance from each other, which preferably consist respectively of a substantially inflexible material, which are connected with each other by means of flexible connecting elements, as a whole a bendable system is produced, which can transmit high torques. The bendability of the shaft is made possible here due to the flexible connecting elements, with the reciprocal arrangement of the segments and of the flexible connecting elements taking place such that a substantially torsion-free structure is produced, so that the disadvantages occurring with the conventional systems owing to the spring structure can be avoided. It is essential here that the individual segments are arranged at a distance from each other, so that they can be tilted relative to each other in accordance with the desired curvature of the flexible shaft. The segments, preferably consisting of an inflexible material, allow at the same time here an optimum guidance of the shaft within the curved, and in particular bendable, tube.

According to a preferred further development, the connecting elements are constructed as discrete connecting elements, i.e. connecting elements separated from the segments, with the connecting elements between two segments or to the end pieces advantageously being formed by at least two, preferably at least three, flexible rods, in particular highly elastic wires, arranged at a distance from each other and preferably parallelly. The rods can be constructed here as rods extending over the entire length of the flexible shaft, penetrating the individual segments. Alternatively, a construction is also conceivable in which the individual rods respectively only connect two or three segments with each other and for further segments respectively further flexible rods are provided. Through the use of flexible rods between the individual segments and in particular through the use of highly elastic wires, the necessary bendability of the shaft is ensured, in which, through at least two and preferably at least three rods being provided arranged at a distance from each other, the necessary torsional stiffness is ensured. The flexible rods are to be arranged here, viewed in the cross-section of the shaft, at such a distance from each other that they also do not touch each other at the maximum provided deflection of the shaft, in order to avoid friction losses.

According to a preferred further development, provision is made that the connecting elements or rods are arranged outside the shaft axis, in which furthermore advantageously the connecting elements or rods, viewed in cross-section, are arranged on at least one circle concentric to the shaft axis. Through the arrangement on a concentric circle, viewed in cross-section, imbalances are avoided, so that high rotational speeds are made possible. Hereby, the connecting elements or rods are advantageously arranged distributed uniformly over the concentric circle.

Through the connecting elements or rods being arranged outside the shaft axis, the possibility is provided that, as in accordance with a preferred further development, the segments respectively have a duct lying in the shaft axis. The duct allows a transportation of media through the flexible shaft, so that for example cooling gas, flushing medium, lubricating medium, pharmaceuticals and suchlike can be supplied to the tool head.

In order to allow for the longitudinal equalization of the rods on rotation, which is necessary in that the rods, in the position outside the curve, compared with the position inside the curve, in accordance with the respective bending of the flexible shaft lie on a greater radius, the construction is advantageously further developed such that the rods are held in receiving bores in at least one of the two end pieces respectively so as to be displaceable in axial direction. Thereby, the rods can dip into the end pieces respectively to different depths, so that the rods themselves do not have to be constructed so as to be elastic in the longitudinal direction. In this connection, it is additionally advantageous when the segments are constructed with bores for the passing through of the rods and are guided displaceably on the rods, so that no tensile stresses occur over the length of the rods.

In order to ensure an optimum power transmission with as little friction as possible, provision is made according to a preferred further development, that the segments are constructed as disc-shaped segments. Here, a construction is preferred in which the segments are constructed with a circular cross-section and are guided with their covering surface on the inner covering surface of the tube. Thereby a guidance of the flexible shaft in the tube is made possible which is as free of play as possible.

In order to also ensure an optimum contour adjustment with a corresponding curvature of the tube, the construction is preferably further developed such that the segments have an outwardly cambered covering surface, with the camber being able to correspond, for example, to the maximum curvature of the tube. Thereby, the friction between the segments is additionally reduced, because no pressure peaks occur on the outer edges of the segments in the contact region with the outer tube.

In order to ensure a uniform distribution of the segments over the length of the shaft, the construction is preferably made such that between the segments respectively at least one spacer element is arranged which is separated from the connecting elements. Thereby, a uniform curvature of the shaft is enforced over its entire length, in which for this purpose preferably all the segments have the same axial length and particularly preferably the distances between the segments are equal. Hereby the spacer elements can preferably be constructed as elastic elements, in order to adapt themselves to the respective curvature of the shaft.

The transmission of particularly high torques with simultaneous maximizing of the torsional stiffness is preferably achieved in that the axial length of the segments is selected to be greater than the distance between the segments. Here, care must merely be taken that the distance between the segments is sufficient in order to permit the desired curvature.

The flexible shaft according to the invention is advantageously used in a hand-operated working apparatus, such as for example in a surgical apparatus, which is provided with a rotary drive which is connected with the end piece of the flexible shaft on the driving side, the end of the drive shaft on the output side being coupled with a rotary head or suchlike.

The invention is illustrated below by aid of an exemplary embodiment illustrated diagrammatically in the drawings. Therein,

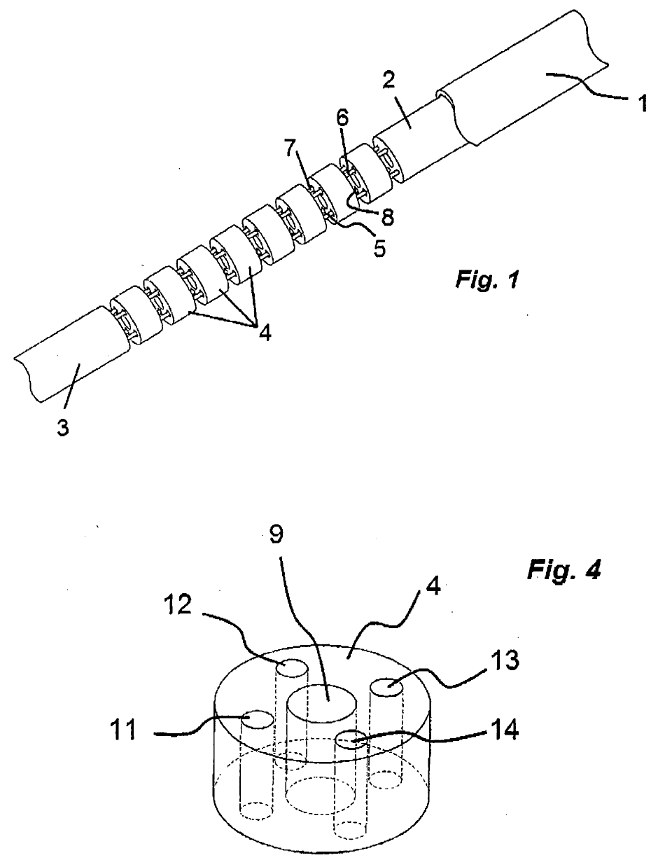

FIG. 1 shows a perspective view of the drive shaft according to the invention,

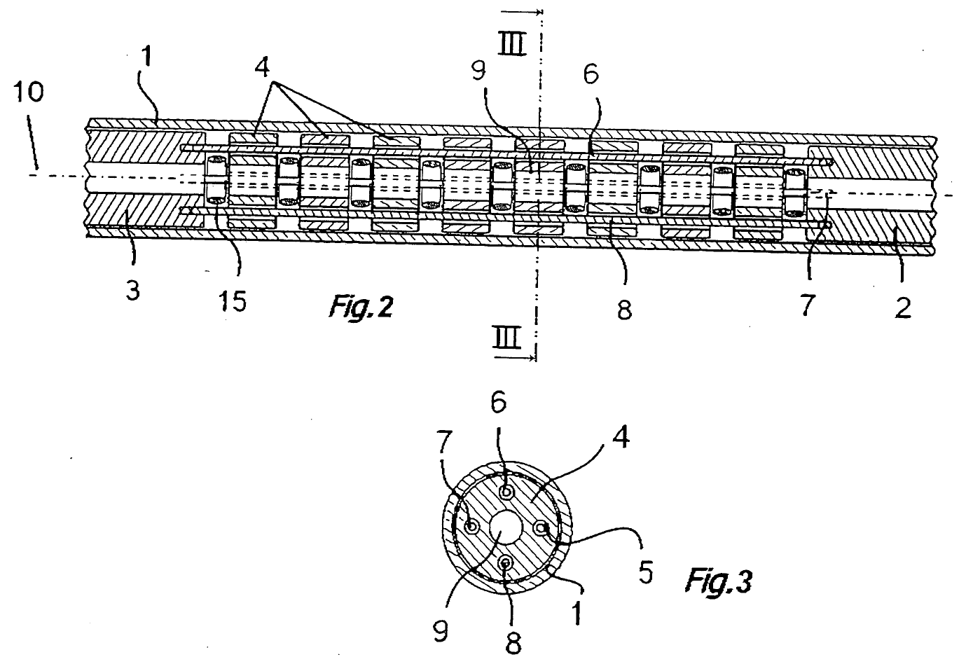

FIG. 2 shows a longitudinal section of the drive shaft,

FIG. 3 shows a cross-section according to line III-III of FIG. 2 and

FIG. 4 shows a detail view of a segment.

In FIG. 1 the flexible tube in which the drive shaft is rotatably guided is designated by 1. The drive shaft consists of an end piece 2 on the driving side and an end piece 3 on the output side. A plurality of segments 4, arranged at a distance from each other, is provided between the end pieces 2 and 3. The segments 4 are connected by means of flexible connecting elements with each other and with the end pieces 2 and 3, the connecting elements in the present case being formed by four flexible rods 5, 6, 7 and 8.

As can be seen in particular in FIG. 2, the rods 5, 6, 7 and 8 are constructed as continuous rods which connect the two end pieces 2 and 3 and penetrate corresponding bores of the segments 4. The rods 5, 6, 7 and 8 dip into corresponding receiving bores in the end pieces 2 and 3, the rods being displaceable in the receiving bores in order to make possible the necessary longitudinal equalization on a bending of the shaft. The rods 5, 6, 7 and 8 are constructed for example from a superelastic alloy. In FIG. 2 it can be additionally seen that the segments 4 have a central opening 9 which is concentric to the shaft axis 10. The openings 9 define a central duct for media of the most varied kinds, the media being able to be transported through a flexible pipe, which is not illustrated for the sake of clarity, which pipe does not co-rotate with the shaft. The spacer elements arranged between the individual segments 4 are designated by 15.

In the cross-sectional illustration according to FIG. 3, the central duct 9 can be seen better, in which likewise it can be seen that the rods 5, 6, 7 and 8 are arranged on a concentric circle to the shaft axis 10.

In the detail illustration of the segment 4 in FIG. 4, the parallel bores 11, 12, 13 and 14 can be seen, which are penetrated by the rods 5, 6, 7 or 8.

1. A flexible drive shaft, comprising:
a first end piece (2) on a driving side of the drive shaft;
a second end piece (3) on an output side of the drive shaft;
a plurality of segments (4) arranged at a distance from each other between the first end piece and the second end piece; and
flexible connecting elements (5, 6, 7, 8),
wherein
the guide shaft is guided rotatably in a curved tube, and the segments are connected with each other and with the first and second end pieces by the connecting elements for transmission of rotary movement.

2. The drive shaft according to claim 1, wherein the connecting elements (5, 6, 7, 8) are at least two flexible rods, said rods being arranged at a distance from each other.

3. The drive shaft according to claim 1, wherein the connecting elements (5, 6, 7, 8) are arranged outside an axis (10) of the drive shaft.

4. The drive shaft according to claim 3, wherein the connecting elements (5, 6, 7, 8) are arranged, in cross-section, on at least one circle concentric to the drive shaft axis (10).

5. The drive shaft according to claim 4, wherein the segments (4) respectively comprise a duct (9) formed along the drive shaft axis (10).

6. The drive shaft according to claim 1, wherein the connecting elements (5, 6, 7, 8) are held in receiving bores formed in one or more of the first and second end pieces (2, 3) respectively, and the connecting elements are displaceable in an axial direction of the drive shaft.

7. The drive shaft according to claim 1, wherein the segments (4) comprise receiving bores (11, 12, 13, 14) for guiding through of the connecting elements (5, 6, 7, 8), and the segments (4) are guided displaceably on the connecting elements.

8. The drive shaft according to claim 1, wherein the segments (4) are disc-shaped segments.

9. The drive shaft according to claim 1, wherein the segments (4) have a circular cross-section, and the segments are guided with their covering surface on an inner covering surface of the tube (1).

10. The drive shaft according to claim 9, wherein the segments (4) have an outwardly cambered covering surface.

11. The drive shaft according to claim 1, further comprising at least one spacer element (15) that is positioned between the segments, and is separate from the connecting elements.

12. The drive shaft according to claim 1, wherein all the segments (4) have an equal axial length.

13. The drive shaft according to claim 1, wherein an axial length of the segments (4) is greater than a distance between the segments (4).

14. A hand-operated working apparatus, comprising:
a rotary drive;
a flexible drive shaft according to claim 1, said drive shaft being connected with the rotary drive, and being guided rotatably in the curved tube; and
a rotary head connected with the second end piece on the output side of the drive shaft.

15. The drive shaft according to claim 1, wherein the tube is a bendable tube.

16. The drive shaft according to claim 2, wherein the connecting elements (5, 6, 7, 8) are at least three flexible rods.

17. The drive shaft according to claim 1, wherein the connecting elements (5, 6, 7, 8) are at least two elastic wires, said wires being arranged at a distance from each another.

18. The drive shaft according to claim 17, wherein the wires are arranged, in cross-section, on at least one circle concentric to an axis (10) of the drive shaft.

19. The hand-operated apparatus according to claim 14, wherein the hand-operated apparatus is a surgical apparatus.

20. The hand-operated apparatus according to claim 19, wherein the connecting elements (5, 6, 7, 8) are at least two flexible rods, said rods being arranged at a distance from each other.
